(19) United States
(12) Patent Application Publication
(10) Pub. No.: US 2014/0224282 A1
(43) Pub. Date: Aug. 14, 2014

(54) METHOD AND APPARATUS FOR WASHING A VEHICLE

(71) Applicant: Alfred Kärcher GmbH & Co. KG, Winnenden (DE)

(72) Inventor: Ralf Schick, Auenwald (DE)

(73) Assignee: Alfred Kärcher GmbH & Co. KG, Winnenden (DE)

(21) Appl. No.: 14/265,552

(22) Filed: Apr. 30, 2014

Related U.S. Application Data
(63) Continuation of application No. PCT/EP2012/071176, filed on Oct. 25, 2012.

(30) Foreign Application Priority Data
Nov. 2, 2011 (DE) 102011054987.0

(51) Int. Cl. B60S 3/04; B05B 7/04

(52) U.S. Cl. CPC B60S 3/044; B60S 3/042; B05B 7/04
USPC 134/36; 239/302; 239/310

(57) ABSTRACT

A method for washing a vehicle is provided, wherein the body of the vehicle is sprayed with pressurized washing liquid via an outlet nozzle of a washing tool and the rims of the vehicle are sprayed with a rim cleaning agent. The washing tool is selectively supplied with at least one of pressurized washing liquid by a high-pressure pump and alkaline rim cleaning agent by a cleaning agent supplying device. A vehicle washing apparatus for performing the method is also provided.

### CROSS-REFERENCE TO RELATED APPLICATIONS

The present application is a continuation of international application number PCT/EP2012/071176, filed on Oct. 25, 2012, which claims priority to German patent application number 10 2011 054 987.0, filed Nov. 2, 2011, the entire specification of both being incorporated herein by reference.

### BACKGROUND OF THE INVENTION

The invention relates to a method for washing a vehicle, wherein the body of the vehicle is sprayed with pressurized washing liquid via an outlet nozzle of a washing tool and the rims of the vehicle are sprayed with a rim cleaning agent.

The invention also relates to a vehicle washing apparatus for performing the aforementioned method, comprising a washing tool having an outlet nozzle and being in flow connection with a high-pressure pump for discharging a pressurized washing liquid via the outlet nozzle, and comprising a cleaning agent supplying device for supplying a rim cleaning agent, and a control device connected to the high-pressure pump and to the cleaning agent supplying device in a signal-transmitting manner.

Self-service vehicle washing apparatuses are known for washing a vehicle, in which the user can apply a pressurized washing liquid to the vehicle body. For this purpose, a washing tool with an outlet nozzle which is in flow connection with a high-pressure pump is made available to the user. For washing the vehicle rims, a cleaning agent supplying device supplies the user with a rim cleaning agent which he can spray onto the rims. The vehicle washing apparatus usually comprises a control device which is connected in a signal-transmitting manner to the high-pressure pump and to the cleaning agent supplying device. The user can select a desired washing program at the control device. For example, in a first step he can select a body washing program, so that he can spray the pressurized washing liquid onto the vehicle body by means of the washing tool, and in a second step he can select a rim washing program in order to spray the rim cleaning agent onto the rims.

Two different washing tools are usually made available to the user for discharging the washing liquid and the rim cleaning agent, for example, two different cleaning lances which each have an outlet nozzle. The two washing tools are supplied with the washing liquid or with the rim cleaning agent via separate feed lines and separate ceiling booms. This makes handling of the vehicle washing apparatus difficult and complicates performance of the washing method.

The object of the invention is, therefore, to simplify the method mentioned at the outset and to develop the vehicle washing apparatus mentioned at the outset in such a way that it is easier to handle.

### SUMMARY OF THE INVENTION

This object is accomplished, in accordance with invention, in a method of the generic kind in that the washing tool is selectively supplied with pressurized washing liquid by a high-pressure pump and/or alkaline rim cleaning agent by a cleaning agent supplying device.

In the method in accordance with the invention, the same washing tool is used for discharging the rim cleaning agent as for spraying the pressurized washing liquid onto the vehicle. An alkaline rim cleaning agent, i.e., an alkaline rim cleaning solution is used. Such alkaline rim cleaning agents are known per se to one skilled in the art. In accordance with the invention, it has been recognized that an alkaline rim cleaning agent can be directed at the vehicle rims by means of a washing tool which is also used for spraying the vehicle body with pressurized washing liquid.

Performance of the method in accordance with the invention is very easy, in particular, for the user of a self-service vehicle washing installation. In a first step, he can select a body washing program and spray the pressurized washing liquid onto the body with the washing tool. The washing liquid is pressurized by a high-pressure pump, preferably at a pressure of 80 bar to 120 bar, in particular, 100 bar. A cleaning lance is preferably used as washing tool. The customer can then select a rim washing program for cleaning the rims, so that an alkaline rim cleaning agent is then supplied to the outlet nozzle of the washing tool without the customer having to change the washing tool. The alkaline rim cleaning agent is supplied by a cleaning agent supplying device, for example, at a pressure of 2 bar to 11 bar, in particular, about 6 bar. Washing liquid, preferably water, can also be added to the alkaline rim cleaning agent by the high-pressure pump. Here the pump capacity of the high-pressure pump can be reduced, for example, to 10% to 20% of the maximum pump capacity. The discharging of the alkaline rim cleaning agent solely by means of the high-pressure pump without using the separate cleaning agent supplying device is disadvantageous as the alkaline rim cleaning agent is very aggressive and the high-pressure pump could be damaged by the aggressive rim cleaning agent. It is, therefore, particularly advantageous for the rim cleaning agent to be discharged without using the high-pressure pump.

The alkaline rim cleaning agent may, for example, be in the form of an aqueous solution of an alkaline rim cleaning chemical. To this end, the alkaline rim cleaning chemical can be mixed with fresh water. The concentration of the rim cleaning chemical in the aqueous solution is preferably 8% to 10%, in particular, 9%.

Water or an aqueous soap solution is preferably used as washing liquid. The soap concentration may, for example, be 0.5%.

It is advantageous if the alkaline rim cleaning agent is discharged in the same way as the pressurized washing liquid via the outlet nozzle of the washing tool. Accordingly, the costumer does not have to make any change to the washing tool and, in particular, to the outlet nozzle if he would like to discharge the alkaline rim cleaning agent instead of the washing liquid. This results in a further simplification of the method.

In a particularly preferred configuration of the method in accordance with the invention, pressurized air is mixed with the alkaline rim cleaning agent. The admixture of the pressurized air results in formation of a rim cleaning foam in the form of a mixture of alkaline rim cleaning agent and air. The discharge of the rim cleaning foam results in particularly effective cleaning of the rims, and the consumption of rim cleaning agent can be kept low. For example, pressurized air can be mixed with a mixture of rim cleaning chemical and water. The mixture of pressurized air, water and alkaline rim cleaning chemical can be applied to the rims of the vehicle via the outlet nozzle of the washing tool, via which, in the case of a body wash, pressurized washing liquid is also applied to the body.

A flat jet nozzle is preferably used as outlet nozzle.

The outlet nozzle may have an elliptical cross section.

It is expedient if the washing tool is connected via a hose line to a ceiling boom which is connected via a line arrangement to a high-pressure pump, the alkaline rim cleaning agent being fed into the line arrangement upstream of the ceiling boom. The use of ceiling booms is known per se to one skilled in the art, in particular, in self-service vehicle washing apparatuses. A ceiling boom can be positioned above the vehicle to be cleaned. It serves to rotatably mount a hose line which is connected at its free end to the washing tool, for example, a cleaning lance. The washing tool can then be rotated together with the hose line through 360° about a vertically aligned axis of rotation. This facilitates the spraying of the vehicle body and the vehicle rims with washing liquid or with the alkaline rim cleaning agent. The rim cleaning agent is preferably fed upstream of the ceiling boom to the line arrangement, via which the ceiling boom is in flow connection with the high-pressure pump.

The rim cleaning agent fed into the line arrangement upstream of the ceiling boom expediently flows through a line section of the line arrangement up to the ceiling boom, the length of the line section being at most two meters. The length of the line section is preferably at most one meter, in particular, at most 0.5 meters. As short a line section of the line arrangement as possible, which is flowed through by the rim cleaning agent, has the advantage that the rim cleaning agent only has to cover a very short flow path in the line arrangement, via which the washing tool is connected to the high-pressure pump. This causes the alkaline rim cleaning agent to be discharged after a very short time via the outlet nozzle of the washing tool after the user has activated the discharge of rim cleaning agent by selecting the corresponding rim washing program. The method, therefore, has very short switchover times for applying a rim cleaning agent to the rims of the vehicle after pressurized washing liquid has been discharged. This enables a further simplification of the method in accordance with invention.

In a vehicle washing apparatus of the kind mentioned at the outset, the object explained hereinabove is accomplished, in accordance with the invention, in that washing liquid from the high-pressure pump and/or alkaline rim cleaning agent from the cleaning agent supplying device is selectively suppliable to the washing tool for discharge of the washing liquid or the rim cleaning agent via the outlet nozzle.

Accordingly, in the vehicle washing apparatus in accordance with the invention, a washing tool is used, with which both a pressurized washing liquid can be applied to the vehicle body and an alkaline rim cleaning agent can be applied to the vehicle rims. The vehicle washing apparatus in accordance with the invention is, therefore, characterized by a constructionally simple design and a simple handling, as has already been explained hereinabove.

The control device of the vehicle washing apparatus in accordance with the invention is expediently programmable so that a customer can selectively choose a body washing program or a rim washing program. For both washing programs he can use the same washing tool, via the outlet nozzle of which both the washing liquid and the alkaline rim cleaning agent can be discharged.

The alkaline rim cleaning agent is expediently dischargeable in the same way via the outlet nozzle of the washing tool as the pressurized washing liquid. It is, therefore, not necessary for the customer to make any change to the washing tool and, in particular, to its outlet nozzle if he would like to discharge the rim cleaning agent instead of pressurized washing liquid by means of the washing tool.

The washing tool is preferably in flow connection with the high-pressure pump via a line arrangement, and a cleaning agent feed line opens at a first port into the line arrangement, the cleaning agent feed line being in flow connection with the cleaning agent supplying device via a closing element controllable by the control device. Pressurized washing liquid can be supplied to the outlet nozzle of the washing tool via the line arrangement, so that it can be directed at the body of the vehicle via the washing tool. An end section of the line arrangement facing the washing tool expediently also serves to supply the rim cleaning agent to the washing tool. For this purpose, a cleaning agent feed line which is in flow connection with the cleaning agent supplying device via a closing element opens into the line arrangement. The closing element is controllable by the control device of the vehicle washing apparatus. If pressurized washing liquid is to be discharged by the washing tool, the closing element can be controlled by the control device so as to assume its closed position and thereby interrupt the flow connection between the line arrangement and the cleaning agent supplying device. If the rim cleaning agent is to be discharged via the washing tool, the closing element can be controlled by the control device so as to assume its open position and thereby open a flow connection from the cleaning agent supplying device via the cleaning agent feed line to the line arrangement.

It is expedient if the closing element is controllable in dependence upon the operating state of the high-pressure pump. This makes it possible, for example, to open the closing element when the high-pressure pump is switched off, and to close the closing element when the high-pressure pump is switched on. As a result, it is alternatively possible for either pressurized washing liquid from the high-pressure pump or alkaline rim cleaning agent from the cleaning agent supplying device to be supplied to the washing tool. To perform a body washing program, the high-pressure pump is switched on and the closing element closed, and to perform a rim washing program, the high-pressure pump is switched off and the closing element opened.

As already mentioned, it is advantageous if a cleaning agent feed line opens into the line arrangement at a first port. It is expedient if upstream of the first port, a first check valve is connected in the line arrangement and a second check valve is connected in the cleaning agent feed line. The check valve connected in the cleaning agent feed line upstream of the first port ensures that no washing liquid can flow from the high-pressure pump via the cleaning agent feed line to the cleaning agent supplying device. In a corresponding manner, the check valve connected in the line arrangement upstream of the first port ensures that when the rim cleaning agent is supplied via the cleaning agent feed line to the washing tool, no rim cleaning agent can flow to the high-pressure pump. The check valve connected in the cleaning agent feed line opens in the direction of flow of the rim cleaning agent and the check valve connected in the line arrangement opens in the direction of flow of the washing liquid.

The line arrangement expediently comprises a ceiling boom. The first port is preferably arranged upstream of the ceiling boom. The rim cleaning agent is, therefore, fed into the line arrangement upstream of the ceiling boom and, like the pressurized washing liquid, can be supplied via the ceiling boom to the washing tool.

The first port at which the cleaning agent feed line opens into the line arrangement is in flow connection with the ceiling boom via a line section of the line arrangement. The length of the line section is expediently at most two meters, in particular, at most one meter, for example, 0.5 meters. The shorter the length of the line section extending from the first port to the ceiling boom, the shorter is the area of the line arrangement that is flowed through by both the washing liquid and the rim cleaning agent. As short a line section as possible ensures that after previous discharge of washing liquid, the rim cleaning agent can be discharged via the outlet nozzle of the washing tool within a short switchover time. If the user changes from a body washing program to a rim washing program, the washing tool, for example, the cleaning lance, is supplied within a very short time with the alkaline rim cleaning agent, which can be directed at the vehicle rims by the user. The switchover time is preferably at most 20 seconds, in particular, at most 15 seconds, for example, 13 seconds.

It is particularly advantageous if the cleaning agent supplying device comprises a connecting line with a fresh water connection, a mixing element being connected in the connecting line for mixing an alkaline rim cleaning chemical into the fresh water. A water line which is in flow connection with a fresh water mains can be connected to the fresh water connection. The fresh water flows through the connecting line and the mixing element. An alkaline rim cleaning chemical is mixed with the fresh water by means of the mixing element. The mixture of fresh water and rim cleaning chemical can then be supplied via the cleaning agent feed line to the washing tool.

A metering pump, for example, the pump inlet of which is connected to a chemical container in which the alkaline rim cleaning chemical is located can be used as mixing element.

It is expedient for the metering pump to be pneumatically driven.

Alternatively, it may be provided that the mixing element is configured as injector. Such injectors are known per se to one skilled in the art. They are configured in the form of nozzles which first narrow and then widen again in the direction of flow. Opening into the injector in the area of the narrowest flow cross section is a chemical line via which the alkaline rim cleaning chemical can be supplied to the injector. If the injector is flowed through by fresh water, the rim cleaning chemical is drawn into the injector and mixed with the fresh water.

In an advantageous embodiment of the vehicle washing apparatus in accordance with the invention, the cleaning agent supplying device comprises a storage container into which the connecting line opens. A mixture of fresh water and alkaline rim cleaning chemical, which is stored in the storage container, can be supplied to the storage container via the connecting line.

It is expedient if the cleaning agent supplying device comprises a pump which is in flow connection at the inlet side with the storage container and at the outlet side with the washing tool. To perform a rim washing program, the pump can be activated so that a rim cleaning agent in the form of a mixture of fresh water and alkaline rim cleaning chemical can then be conveyed by the pump to the washing tool. The use of the pump enables a particularly rapid pressurization of the rim cleaning chemical. This results in a further decrease in the switchover time so that after the discharge of pressurized washing liquid, the rim cleaning agent can be discharged within a very short time via the washing tool.

In a particularly preferred embodiment, the vehicle washing apparatus in accordance with the invention comprises a pressurized air supplying device for producing a mixture of pressurized air and rim cleaning agent. The pressurized air can be mixed with the alkaline rim cleaning agent so that a rim cleaning foam forms, which can be applied to the vehicle rims via the washing tool. This enables particularly effective rim cleaning. In addition, this has the advantage that the consumption of rim cleaning agent can be kept particularly low.

The pressurized air supplying device preferably comprises a source of pressurized air to which a pressurized air feed line is connected, the pressurized air feed line opening at a second port into a cleaning agent feed line via which the washing tool is in flow connection with the cleaning agent supplying device. A pressurized air compressor is preferably used as source of pressurized air.

Preferably, upstream of the second port, a third check valve is connected in the pressurized air feed line, and upstream of the second port, a fourth check valve is connected in the cleaning agent feed line. The third check valve opens in the direction of flow of the pressurized air, and the fourth check valve opens in the direction of flow of the rim cleaning agent. The third check valve ensures that the rim cleaning agent cannot get to the source of pressurized air via the pressurized air feed line, and the fourth check valve ensures that the pressurized air cannot get to the cleaning agent supplying device via the cleaning agent feed line.

It is expedient for a throttle element to be connected in the cleaning agent feed line upstream of the fourth check valve. The throttle element may, for example, be configured in the form of a throttle valve. The pressure of the rim cleaning agent prevailing in the cleaning agent feed line downstream of the throttle element can be limited by means of the throttle element. In addition, the throttle element also enables a limitation of the flow rate of the rim cleaning agent.

The vehicle washing apparatus may comprise several washing sites, at each of which a vehicle can be washed. Each washing site can have a high-pressure pump associated with it for supplying pressurized washing liquid, and the alkaline rim cleaning agent can be supplied to all of the washing sites by the cleaning agent supplying device.

In a vehicle washing apparatus with four washing sites, the pressure of the rim cleaning agent upstream of the throttle element may, for example, be at most about 11 bar.

The pressure in the pressurized air feed line upstream of the second port may, for example, be 2 to 5 bar, in particular, 2.5 bar.

The following description of preferred embodiments of the invention will serve in conjunction with the drawings for further explanation.

### BRIEF DESCRIPTION OF THE DRAWINGS

FIG. 1 shows a schematic representation of a first embodiment of a vehicle washing apparatus in accordance with the invention; and

FIG. 2 shows a schematic representation of a second embodiment of a vehicle washing apparatus in accordance with the invention.

### DETAILED DESCRIPTION OF THE INVENTION

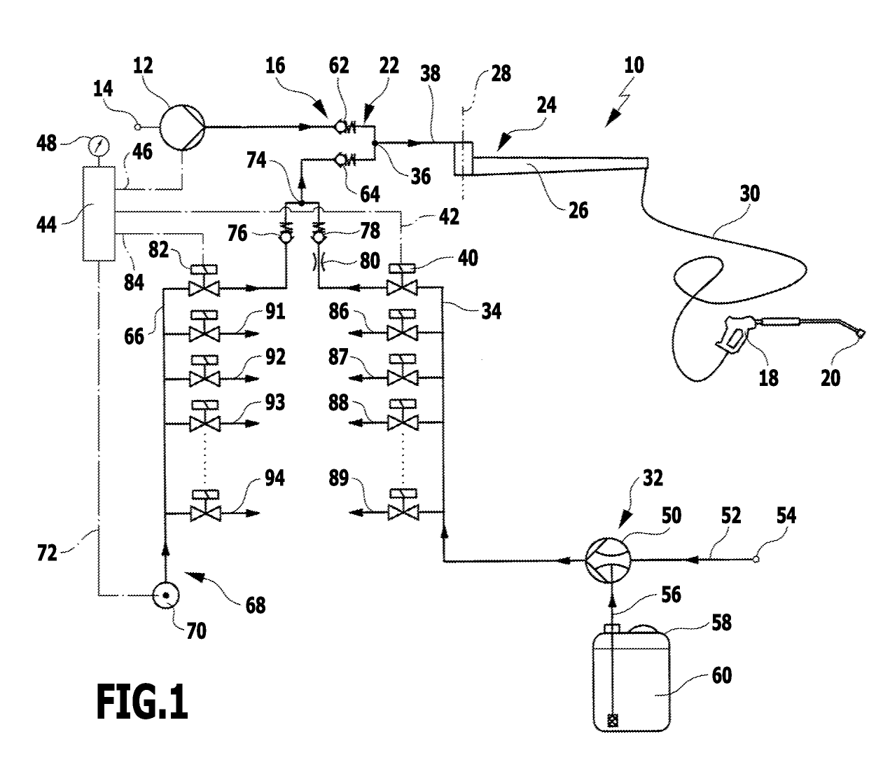

A vehicle washing apparatus denoted in its entirety by reference numeral 10 is shown schematically in FIG. 1. The vehicle washing apparatus 10 comprises a high-pressure pump 12, the pump inlet of which is in flow connection with a supply connection 14. A water line can be connected to the supply connection 14. The pump outlet is in flow connection via a line arrangement 16 with a washing tool which, in the illustrated embodiment, is configured as a cleaning lance 18. The cleaning lance 18 comprises an outlet nozzle in the form of a spray nozzle 20. The nozzle cross section of the spray nozzle 20 is at most 1 mm, in particular, about 0.8 mm. A pressurized washing liquid, preferably water or an aqueous soap solution, can be supplied to the spray nozzle 20 via the line arrangement 16.

The line arrangement 16 comprises a first supply line 22, which is connected to the pressure outlet of the high-pressure pump 12, and to which is connected a ceiling boom 24 with a rotary arm 26, which is freely rotatable about a vertical axis of rotation 28. A hose line 30 is connected to the rotary arm 28. The cleaning lance 18 is connected to the free end of the hose line 30.

The vehicle washing apparatus 10 also comprises a cleaning agent supplying device 32, which supplies an alkaline rim cleaning agent. The cleaning agent supplying device 32 is in flow connection with the line arrangement 16 via a cleaning agent feed line 34. The cleaning agent feed line 34 opens at a first port 36 upstream of the ceiling boom 24 into the supply line 22 of the line arrangement 16. A line section 38 of the line arrangement 16 extends between the first port 36 and the ceiling boom 24. The length of the line section 38 is at most two meters. Preferably, the length of the line section 38 is at most one meter, in particular, at most 0.5 meters.

A controllable closing element in the form of a first magnetic valve 40, the control input of which is in electrical connection with a control device 44 of the vehicle washing apparatus 10 via an electric control line 42 shown in a dot-and-dash line in the drawings, is connected in the cleaning agent feed line 34. The high-pressure pump 12 is in electrical connection with the control device 44 via a further electric control line 46.

The control device 44 comprises a program selector switch 48, which can be actuated by the user of the vehicle washing apparatus 10. The control device 44 is programmable by the manufacture and/or by the operator of the vehicle washing apparatus 10, and by means of the program selector switch 48 the user of the vehicle washing apparatus 10 has the possibility of selecting various washing programs one after the other.

The cleaning agent supplying device 32 comprises a mixing element in the form of an injector 50 which is connected in a connecting line 52 to which the cleaning agent feed line 34 is connected. The connecting line 52 is connected to a fresh water connection 54 via which the connecting line 52 can be supplied with fresh water.

A chemical line 56, which with its end facing away from the injector 50 enters a chemical container 58, opens into the injector 50. The chemical container 58 accommodates an alkaline rim cleaning chemical 60. When fresh water flows through the connecting line 52, the alkaline rim cleaning chemical 60 is drawn into the injector 50 via the chemical line 56. The rim cleaning chemical 60 is, therefore, mixed with the fresh water, and a mixture of fresh water and rim cleaning chemical is supplied as rim cleaning agent to the cleaning lance 18 via the cleaning agent feed line 34, the line section 38 of the line arrangement 16, the ceiling boom 24 and the hose line 30.

Upstream of the first port 36, a first check valve 62 which opens in the direction of flow of the washing liquid pressurized by the high-pressure pump 12 is connected in the supply line 22. A second check valve 64 which opens in the direction of flow of the rim cleaning agent is connected in the cleaning agent feed line 34 upstream of the first port 36.

Upstream of the second check valve 64, a pressurized air feed line 66, via which the cleaning agent feed line 34 is in flow connection with a pressurized air supplying device 68 of the vehicle washing apparatus 10, opens into the cleaning agent feed line 34. The pressurized air supplying device 68 comprises a source of pressurized air in the form of a pressurized air compressor 70, to the outlet of which the pressurized air feed line 66 is connected. The pressurized air compressor 70 can be in electrical connection with the control device 44 via an electric control line 72.

The pressurized air feed line 66 opens at a second port 74, upstream of the second check valve 64, into the cleaning agent feed line 34, so that pressurized air supplied by the pressurized air compressor 70 can be mixed with the rim cleaning agent supplied by the cleaning agent supplying device 32, which flows through the cleaning agent feed line 34. This has the consequence that downstream of the second port 74 a rim cleaning foam forms, which can be supplied to the cleaning lance 18 via the line section 38, the ceiling boom 24 and the hose line 30.

Upstream of the second port 74, a third check valve 76 which opens in the direction of flow of the pressurized air is connected in the pressurized air feed line 66. A fourth check valve 78 which opens in the direction of flow of the rim cleaning agent is connected in the cleaning agent feed line 34 upstream of the second port 74. A throttle element 80 by means of which the flow rate of the rim cleaning agent can be limited is connected in the cleaning agent feed line 34 in the area between the fourth check valve 78 and the first magnetic valve 40.

A controllable closing element in the form of a second magnetic valve 82 is connected in the pressurized air feed line 66 upstream of the third check valve 76. The second magnetic valve 82 is in electrical connection with the control device 44 via an electric control line 84.

The two magnetic valves 40 and 82 are switched by the control device 44 in dependence upon the operating state of the high-pressure pump 12. If a user of the vehicle washing apparatus 10 selects a body washing program by means of the program selector switch 48, the high-pressure pump 12 is put into operation and the two magnetic valves 40 and 82 are closed. This has the consequence that a pressurized washing liquid, for example, water is supplied to the cleaning lance 18 by the high-pressure pump 12 via the line arrangement 16. The pressure of the washing liquid is, for example, 100 bar. The washing liquid can be directed at the body of a vehicle to be washed via the spray nozzle 20 of the cleaning lance 18.

If the user subsequently selects a rim washing program by means of the program selector switch 48, the high-pressure pump 12 is switched off and the two magnetic valves 40 and 82 are opened. As a result, the alkaline rim cleaning agent in the form of a mixture of fresh water and alkaline rim cleaning chemical supplied by the cleaning agent supplying device 32 can flow through the cleaning agent feed line 34, pressurized air being admixed at the second port 74, so that downstream of the second port 74 a rim cleaning foam forms, which is supplied to the cleaning lance 18 via the line section 38, the ceiling boom 24 and the hose line 30 and can be directed at the rims of the vehicle to be cleaned via the spray nozzle 20.

The cleaning lance 18 is therefore used both for discharging pressurized washing liquid and for discharging alkaline rim cleaning agent. No changes to the cleaning lance and, in particular, to the spray nozzle are required therefor.

If pressurized washing liquid is supplied by the high-pressure pump 12, it can flow through the supply line 22. The second check valve 64 ensures that the pressurized washing liquid cannot get to the second port 74 and via the latter to the pressurized air feed line 66 and to the cleaning agent feed line 34. If instead the cleaning lance 18 is supplied with a rim cleaning foam, it can flow through the second check valve 64. The first check valve 62 ensures that the rim cleaning foam cannot get to the high-pressure pump 12.

The vehicle washing apparatus 10 comprises in the illustrated embodiment several washing sites at each of which a vehicle to be cleaned can be positioned. Arranged at each washing site is a ceiling boom 24, which is in flow connection via a supply line with a high-pressure pump associated with the respective washing site, and which is connected via a hose line to the cleaning lance of the washing site. The cleaning agent supplying device 32, like the pressurized air supplying device 68, is associated with all of the washing sites, so that an alkaline rim cleaning agent with which pressurized air is mixed can be supplied to all of the washing sites by the cleaning agent supplying device 32 and the pressurized air supplying device 68 so that a rim cleaning foam forms. For this purpose, several branch lines 86, 87, 88, 89, in each of which a separate controllable closing element in the form of a magnetic valve is connected, branch off from the cleaning agent feed line 34 upstream of the throttle element 80, and an identical number of branch lines 91, 92, 93, 94, in each of which a second magnetic valve is connected, branch off from the pressurized air feed line 66 upstream of the third check valve 76. All of the magnetic valves are in electrical connection with the control device 44 of the vehicle washing apparatus via electric control lines not shown in the drawings. Associated with each washing site is a separate program selector switch by means of which the user can select a washing program. Washing liquid pressurized by a high-pressure pump or an alkaline rim cleaning agent supplied by the cleaning agent supplying device 32, with which pressurized air is mixed, can therefore be selectively supplied to the respective cleaning lance of the washing site.

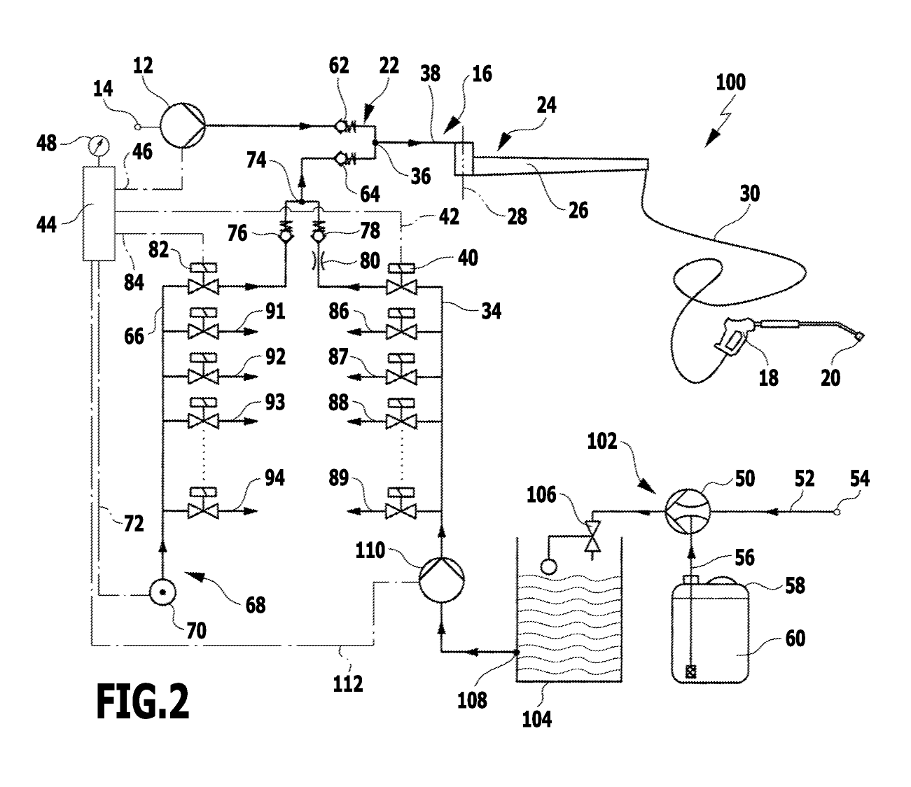

A second embodiment of a vehicle washing apparatus in accordance with the invention, which is denoted in its entirety by reference numeral 100 is shown in FIG. 2. The vehicle washing apparatus 100 is substantially identical in construction to the vehicle washing apparatus 10 described hereinabove with reference to FIG. 1. Therefore, the same reference numerals are used for identical components in FIG. 2 as in FIG. 1. To avoid repetitions, reference is made to the above explanations in connection with these components.

The vehicle washing apparatus 100 shown in FIG. 2 differs from the vehicle washing apparatus 10 shown in FIG. 1 in that a cleaning agent supplying device 102 is used, which comprises not only an injector 50 which is connected in a connecting line 52, so that an alkaline rim cleaning chemical 60 from a chemical container 58 can be mixed with the fresh water flowing through the connecting line 52, but, in addition, the cleaning agent supplying device 102 comprises a storage container 104 into which the connecting line 52 opens via an inlet valve 106 which is dependent upon the filling level of the storage container 104. A mixture of fresh water and alkaline rim cleaning chemical can be stored in the storage container 104. The cleaning agent feed line 34 is connected to a container outlet 108 of the storage container 104, and a pump 110 is connected in the cleaning agent feed line 34 upstream of all of the branch lines 91, 92, 93, 94. The mixture of fresh water and rim cleaning chemical can be conveyed by the pump 110 from the storage container 104 and delivered to the line arrangement 16 via the cleaning agent feed line 34. The pump 110 is in electrical connection with the control device 44 of the vehicle washing apparatus 100 via an electric control line 112.

A ceiling boom 24, to which a hose line 30 carrying a cleaning lance 18 with a spray nozzle 20 at its free end is connected, is also arranged at each washing site in the vehicle washing apparatus 100 shown in FIG. 2. Each ceiling boom 24 of the washing sites is in flow connection via a supply line 22 with a high-pressure pump 12 associated with the respective washing site so that, as required, each cleaning lance 18 can be supplied with pressurized washing liquid by the respective high-pressure pump 12.

A program selector switch 48 by means of which the user can select a washing program is also associated with each washing site in the vehicle washing apparatus 100. To spray the vehicle body, the user can select a body washing program. The pressurized washing liquid which the user can direct at the vehicle body is then supplied to the respective cleaning lance 18. If the user selects a rim washing program instead, the high-pressure pump 12 associated with the respective washing site is switched off, and instead the cleaning lance is supplied with an alkaline rim cleaning agent in the form of a mixture of fresh water, alkaline rim cleaning chemical and pressurized air. The alkaline rim cleaning agent can be applied to the rims to be cleaned in the form of a rim cleaning foam by means of the cleaning lance. The user does not have to make any changes to the respective cleaning lance when changing from pressurized washing liquid to the rim cleaning agent.

The vehicle washing apparatuses 10 and 100 are, therefore, characterized by a constructionally simple design as well as by an easy handling.

1. A method for washing a vehicle, wherein the body of the vehicle is sprayed with pressurized washing liquid via an outlet nozzle of a washing tool and the rims of the vehicle are sprayed with a rim cleaning agent, and wherein the washing tool is selectively supplied with at least one of pressurized washing liquid by a high-pressure pump and alkaline rim cleaning agent by a cleaning agent supplying device.

2. The method in accordance with claim 1, wherein the alkaline rim cleaning agent is discharged in the same way as the pressurized washing liquid via the outlet nozzle.

3. The method in accordance with claim 1, wherein pressurized air is mixed with the alkaline rim cleaning agent.

4. The method in accordance with claim 1, wherein the washing tool is connected via a hose line to a ceiling boom which is connected via a line arrangement to the high-pressure pump, the alkaline rim cleaning agent being fed into the line arrangement upstream of the ceiling boom.

5. The method in accordance with claim 4, wherein the rim cleaning agent fed into the line arrangement upstream of the ceiling boom flows through a line section of the line arrangement, the length of the line section being at most two meters.

6. A vehicle washing apparatus for performing the method in accordance with claim 1, comprising a washing tool having an outlet nozzle and being in flow connection with a high-pressure pump for discharging a pressurized washing liquid via the outlet nozzle, and comprising a cleaning agent supplying device for supplying a rim cleaning agent, and a control device connected to the high-pressure pump and to the cleaning agent supplying device in a signal-transmitting manner, wherein at least one of washing liquid from the high-pressure pump and alkaline rim cleaning agent from the cleaning agent supplying device is selectively suppliable to the washing tool for discharge of the washing liquid or the rim cleaning agent via the outlet nozzle.

7. The vehicle washing apparatus in accordance with claim 6, wherein the washing tool is in flow connection with the high-pressure pump via a line arrangement, and wherein a cleaning agent feed line, which is in flow connection with the cleaning agent supplying device via a closing element controllable by the control device, opens at a first port into the line arrangement.

8. The vehicle washing apparatus in accordance with claim 7, wherein the closing element is controllable in dependence upon the operating state of the high-pressure pump.

9. The vehicle washing apparatus in accordance with claim 7, wherein upstream of the first port, a first check valve is connected in the line arrangement and a second check valve is connected in the cleaning agent feed line.

10. The vehicle washing apparatus in accordance with claim 7, wherein the line arrangement comprises a ceiling boom, and the first port is arranged upstream of the ceiling boom.

11. The vehicle washing apparatus in accordance with claim 10, wherein the first port is in flow connection with the ceiling boom via a line section, the length of the line section being at most two meters.

12. The vehicle washing apparatus in accordance with claim 6, wherein the cleaning agent supplying device comprises a connecting line with a fresh water connection, a mixing element being connected in the connecting line for mixing an alkaline rim cleaning chemical into the fresh water.

13. The vehicle washing apparatus in accordance with claim 12, wherein the mixing element is configured as injector.

14. The vehicle washing apparatus in accordance with claim 12, wherein the cleaning agent supplying device comprises a storage container into which the connecting line opens.

15. The vehicle washing apparatus in accordance with claim 14, wherein the cleaning agent supplying device comprises a pump which is in flow connection at the inlet side with the storage container and at the outlet side with the washing tool.

16. The vehicle washing apparatus in accordance with claim 6, said vehicle washing apparatus comprising a pressurized air supplying device for producing a mixture of pressurized air and rim cleaning agent.

17. The vehicle washing apparatus in accordance with claim 16, wherein the pressurized air supplying device comprises a source of pressurized air to which a pressurized air feed line is connected, the pressurized air feed line opening at a second port into a cleaning agent feed line via which the rim cleaning agent is suppliable to the washing tool.

18. The vehicle washing apparatus in accordance with claim 17, wherein upstream of the second port, a third check valve is connected in the pressurized air feed line and a fourth check valve is connected in the cleaning agent feed line.

19. The vehicle washing apparatus in accordance with claim 18, wherein a throttle element is connected in the cleaning agent feed line upstream of the fourth check valve.
